(19) United States
(12) Patent Application Publication
(10) Pub. No.: US 2013/0003346 A1
(43) Pub. Date: Jan. 3, 2013

(54) COMPACT HIGH EFFICIENCY REMOTE LED MODULE

(75) Inventors: RONAN LETOQUIN, FREMONT, CA (US); PETER GUSCHL, CARPINTERIA, CA (US); JAMES IBBETSON, SANTA BARBARA, CA (US); ERIC TARSA, GOLETA, CA (US); TAO TONG, OXNARD, CA (US); ZONGJIE YUAN, VENTURA, CA (US); BERND KELLER, SANTA BARBARA, CA (US)

(73) Assignee: CREE, Inc.

(21) Appl. No.: 13/536,707

(22) Filed: Jun. 28, 2012

Related U.S. Application Data
(60) Provisional application No. 61/502,224, filed on Jun. 28, 2011.

(51) Int. Cl. F21V 9/16; F21V 29/00; F21V 13/02

(52) U.S. Cl. 362/84; 362/260; 362/235

(57) ABSTRACT

Solid state modules and fixtures comprising different combinations and arrangements of a light source, one or more wavelength conversion materials, thermally conductive connection adapters allowing dissipation of heat outside of the module, and a remote power supply unit. This arrangement allows for greater thermal efficiency and reliability while employing solid state lighting and providing emission patterns that are equivalent with ENERGY STAR® standards. Some embodiments additionally place compensation circuits, previously included with power supply units, on the optical element itself, remote from the power supply unit. Various embodiments of the invention may be used to address many of the difficulties associated with utilizing efficient solid state light sources such as LEDs in the fabrication of lamps or bulbs suitable for direct replacement of traditional incandescent bulbs or fixtures using bulbs.

This application claims the benefit of U.S. Provisional Patent Application Ser. No. 61/339,516, filed on Mar. 3, 2010, U.S. Provisional Patent Application Ser. No. 61/339,515, filed on Mar. 3, 2010, U.S. Provisional Patent Application Ser. No. 61/386,437, filed on Sep. 24, 2010, U.S. Provisional Patent Application Ser. No. 61/434,355, filed on Jan. 19, 2011, U.S. Provisional Patent Application Ser. No. 61/435,326, filed on Jan. 23, 2011, U.S. Provisional Patent Application Ser. No. 61/435,759, filed on Jan. 24, 2011, and U.S. Provisional Patent Application Ser. No. 61/502,224, filed on Jun. 28, 2011.

### BACKGROUND OF THE INVENTION

1. Field of the Invention

This invention relates to solid state lamps and modules and in particular to efficient and reliable light emitting diode (LED) based lamps and modules capable of producing omnidirectional emission patterns.

2. Description of the Related Art

Incandescent or filament-based lamps or bulbs are commonly used as light sources for both residential and commercial facilities. However, such lamps are highly inefficient light sources, with as much as 95% of the input energy lost, primarily in the form of heat or infrared energy. One common alternative to incandescent lamps, so-called compact fluorescent lamps (CFLs), are more effective at converting electricity into light but require the use of toxic materials which, along with its various compounds, can cause both chronic and acute poisoning and can lead to environmental pollution. One solution for improving the efficiency of lamps or bulbs is to use solid state devices such as light emitting diodes (LED or LEDs), rather than metal filaments, to produce light.

Light emitting diodes generally comprise one or more active layers of semiconductor material sandwiched between oppositely doped layers. When a bias is applied across the doped layers, holes and electrons are injected into the active layer where they recombine to generate light. Light is emitted from the active layer and from various surfaces of the LED.

In order to use an LED chip in a circuit or other like arrangement, it is known to enclose an LED chip in a package to provide environmental and/or mechanical protection, color selection, light focusing and the like. An LED package also includes electrical leads, contacts or traces for electrically connecting the LED package to an external circuit. In a typical LED package 10 illustrated in FIG. 1, a single LED chip 12 is mounted on a reflective cup 13 by means of a solder bond or conductive epoxy. One or more wire bonds 11 connect the ohmic contacts of the LED chip 12 to leads 15A and/or 15B, which may be attached to or integral with the reflective cup 13. The reflective cup may be filled with an encapsulant material 16 which may contain a wavelength conversion material such as a phosphor. Light emitted by the LED at a first wavelength may be absorbed by the phosphor, which may responsively emit light at a second wavelength. The entire assembly is then encapsulated in a clear protective resin 14, which may be molded in the shape of a lens to collimate the light emitted from the LED chip 12. While the reflective cup 13 may direct light in an upward direction, optical losses may occur when the light is reflected (i.e. some light may be absorbed by the reflective cup due to the less than 100% reflectivity of practical reflector surfaces). In addition, heat retention may be an issue for a package such as the package 10 shown in FIG. 1a, since it may be difficult to extract heat through the leads 15A, 15B.

A conventional LED package 20 illustrated in FIG. 2 may be more suited for high power operations which may generate more heat. In the LED package 20, one or more LED chips 22 are mounted onto a carrier such as a printed circuit board (PCB) carrier, substrate or submount 23. A metal reflector 24 mounted on the submount 23 surrounds the LED chip(s) 22 and reflects light emitted by the LED chips 22 away from the package 20. The reflector 24 also provides mechanical protection to the LED chips 22. One or more wirebond connections 27 are made between ohmic contacts on the LED chips 22 and electrical traces 25A, 25B on the submount 23. The mounted LED chips 22 are then covered with an encapsulant 26, which may provide environmental and mechanical protection to the chips while also acting as a lens. The metal reflector 24 is typically attached to the carrier by means of a solder or epoxy bond.

LED chips, such as those found in the LED package 20 of FIG. 2 can be coated by conversion material comprising one or more phosphors, with the phosphors absorbing at least some of the LED light. The LED chip can emit a different wavelength of light such that it emits a combination of light from the LED and the phosphor. The LED chip(s) can be coated with a phosphor using many different methods, with one suitable method being described in U.S. patent application Ser. Nos. 11/656,759 and 11/899,790, both to Chitnis et al. and both entitled “Wafer Level Phosphor Coating Method and Devices Fabricated Utilizing Method”. Alternatively, the LEDs can be coated using other methods such as electrophoretic deposition (EPD), with a suitable EPD method described in U.S. patent application Ser. No. 11/473,089 to Tarsa et al. entitled “Close Loop Electrophoretic Deposition of Semiconductor Devices”.

LED chips which have a conversion material in close proximity or as a direct coating have been used in a variety of different packages, but experience some limitations based on the structure of the devices. When the phosphor material is on or in close proximity to the LED epitaxial layers (and in some instances comprises a conformal coat over the LED), the phosphor can be subjected directly to heat generated by the chip which can cause the temperature of the phosphor material to increase. Further, in such cases the phosphor can be subjected to very high concentrations or flux of incident light from the LED. Since the conversion process is in general not 100% efficient, excess heat is produced in the phosphor layer in proportion to the incident light flux. In compact phosphor layers close to the LED chip, this can lead to substantial temperature increases in the phosphor layer as large quantities of heat are generated in small areas. This temperature increase can be exacerbated when phosphor particles are embedded in low thermal conductivity material such as silicone which does not provide an effective dissipation path for the heat generated within the phosphor particles. Such elevated operating temperatures can cause degradation of the phosphor and surrounding materials over time, as well as a reduction in phosphor conversion efficiency and a shift in conversion color.

Lamps have also been developed utilizing solid state light sources, such as LEDs, in combination with a conversion material that is separated from or remote to the LEDs. Such arrangements are disclosed in U.S. Pat. No. 6,350,041 to Tarsa et al., entitled “High Output Radial Dispersing Lamp Using a Solid State Light Source.” The lamps described in this patent can comprise a solid state light source that transmits light through a separator to a disperser having a phosphor. The disperser can disperse the light in a desired pattern and/or changes its color by converting at least some of the light to a different wavelength through a phosphor or other conversion material. In some embodiments the separator spaces the light source a sufficient distance from the disperser such that heat from the light source will not transfer to the disperser when the light source is carrying elevated currents necessary for room illumination. Additional remote phosphor techniques are described in U.S. Pat. No. 7,614,759 to Negley et al., entitled “Lighting Device.”

In conformal or adjacent phosphor arrangements heat generated in the phosphor layer during the conversion process may be conducted or dissipated via the nearby chip or substrate surfaces. By comparison, one potential disadvantage of lamps incorporating remote phosphors arrangements is that the phosphor can be subject to inadequate thermally conductive heat dissipation paths. Without an effective heat dissipation pathway, thermally isolated remote phosphors may suffer from elevated operating temperatures that in some instances can be even higher than the temperature in comparable conformal coated layers. This can offset some or all of the benefit achieved by placing the phosphor remotely with respect to the chip. Stated differently, remote phosphor placement relative to the LED chip can reduce or eliminate direct heating of the phosphor layer due to heat generated within the LED chip during operation, but the resulting phosphor temperature decrease may be offset in part or entirely due to heat generated in the phosphor layer itself during the light conversion process and lack of a suitable thermal path to dissipate this generated heat.

Another issue affecting the implementation and acceptance of lamps utilizing solid state light sources relates to the nature of the light emitted by the light source itself. In order to fabricate efficient lamps or bulbs based on LED light sources (and associated conversion layers), it is typically desirable to place the LED chips or packages in a co-planar arrangement. This facilitates manufacture and can reduce manufacturing costs by allowing the use of conventional production equipment and processes. However, co-planar arrangements of LED chips typically produce a forward directed light intensity profile (e.g., a Lambertian profile). Such beam profiles are generally not desired in applications where the solid-state lamp or bulb is intended to replace a conventional lamp such as a traditional incandescent bulb, which has a much more omni-directional beam pattern. While it is possible to mount the LED light sources or packages in a three-dimensional arrangement, such arrangements are generally difficult and expensive to fabricate.

Conventional incandescent, fluorescent or halogen based light bulbs can provide uniform or near uniform distribution of light that can be compatible with many different lighting applications. One disadvantage of the light sources is that they are designed to run hot and do not efficiently dissipate heat. Their primary heat dissipation paths are convection and radiation through the bulb glass. Bulbs with Edison or GU type sockets are used for electrical connection and do not provide an efficient heat dissipation path.

LED based light bulbs are now commercially available, but very few offer uniform light distribution patterns comparable to conventional light bulbs. The light bulbs with emission patterns approaching those of conventional light bulbs can suffer from inadequate heat dissipation arrangements. Many of these bulbs have internal power supply units, and rely on their integrated bulb heat dissipation mechanisms (e.g. heat sink, fan) to dissipate heat. These bulbs are designed so that most of the heat generated by the LEDs and/or the power supply is dissipated through the heat sink. This heat dissipation arrangement can be very limiting and can result in sufficient thermal dissipation being strongly dependent upon the drive signal to the LEDs, and the bulb or fixture orientation. The bulb can more efficiently dissipate heat in one orientation compared to its heat dissipation when the bulb is in a different orientation. These heat dissipation limitations can reduce the lifetime of LED light emitter(s) and can prevent the use of power levels necessary to allow for replacement of 60, 75 and 100 W incandescent bulbs. Of these LED bulbs that approach and exceed 60 W incandescent equivalent light output, the heat sink temperature can become elevated (e.g. 75° C. or higher) which can also significantly reduce the lifetime of the power supply components, such as the electrolytic capacitors and diodes.

### SUMMARY OF THE INVENTION

The present invention provides LED based light sources or modules with improved thermal management features that allow it to operate at a lower temperature, which in turn can allow the LEDs in the modules to be driven by a higher drive signal, or for the bulbs to have a smaller heat sink. The LED modules generally comprise an optical element on a heat sink, with a remote phosphor over the optical element so that light from the optical element's LEDs passes through the remote phosphor, and a remote power supply that provides electrical power to the LEDs. The present invention also comprises features, such as a conductive adapter, that promote the conduction of heat from the LEDs to the features of a light fixture in which the LED module is mounted. In some embodiments an adapter can be used to mount the LED module's heat sink to the light fixture, with the adapter being thermally conductive to transfer heat from the heat sink to the fixture. Utilizing thermally conductive elements and surface features of the light fixture to conduct heat away from the LED module and dissipate heat into the ambient allows the LEDs to operate at a lower temperature, higher efficiency and with better reliability.

The remote phosphor can comprise a thermally conductive material that aids in the transfer of heat generated during the conversion process to the ambient or the heat sink. The LEDs and remote phosphor can also be arranged so that the LED module generates light with an omnidirectional emission pattern. The emission can have a good color temperature, color rendering index, and color consistency at different viewing angles, making the bulbs suitable for general illumination. The LED modules and light fixtures according to the present invention are also arranged so that the LED module power supply unit can be spatially remote and thermally essentially insulated from the light generating elements of the LED module. This reduces or eliminates heat generation in the vicinity of the power supply unit, thereby allowing it to operate at a lower temperature, higher reliability, and with greater efficiency.

One configuration of the present disclosure provides a lighting module comprising an optical element on a heat sink. The module further includes a wavelength conversion material on the heat sink and spaced from the optical element, wherein said module is arranged to be capable of connecting to a fixture via a connection adapter, the connection adapter being thermally and electrically conductive. In addition the module also includes a thermally remote power supply unit (PSU).

Another configuration of the present disclosure provides a lighting module comprising an optical element on a heat sink. The lighting module also includes a compensation circuit on the optical element and a conductive connection adapter on the lighting module allowing the lighting module to be capable of connecting to a fixture. The module further includes a wavelength conversion material over said optical element.

Yet another configuration of the present disclosure provides a lighting module comprising an optical element on a heat sink, the heat sink comprising a plurality of heat fins. The module further includes a conductive connection adapter on the lighting module allowing the lighting module to be capable of connecting to a fixture and a remote PSU. In addition, the module includes a remote wavelength conversion material over said optical element, wherein the module is arranged to have a substantially uniform emission pattern.

An additional configuration of the present disclosure provides a lighting fixture comprising an outer fixture housing and a lighting module. The lighting module comprising an optical element on a heat sink and a wavelength conversion material on the heat sink and spaced from the optical element. The module also includes a thermally and electrically conductive connection adapter, capable of connecting the module to the outer fixture housing and a thermally remote power supply unit (PSU).

These and other aspects and advantages of the invention will become apparent from the following detailed description and the accompanying drawings which illustrate by way of example the features of the invention.

### BRIEF DESCRIPTION OF THE DRAWINGS

FIG. 1 shows a sectional view of one embodiment of a prior art LED lamp;

FIG. 2 shows a sectional view of another embodiment of a prior art LED lamp;

FIG. 3a is a perspective view of one embodiment of an LED module according to the present invention;

FIG. 3b is a side view of one embodiment of an LED module according to the present invention;

FIG. 4 is a cross-section view of an LED modules according to the present invention;

FIG. 5 is a side exploded view of an LED module according to the present invention;

FIG. 6 is a perspective exploded view of the LED module shown in FIG. 5;

FIG. 7 is a top view of one embodiment of an optical element according to the present invention;

FIG. 8 is a perspective view one embodiment of a heat sink according to the present invention;

FIG. 9 is a another perspective view of one embodiment of a heat sink according to the present invention;

FIG. 10 is a sectional perspective view of one embodiment of a heat sink according to the present invention;

FIG. 11 is a top view of a heat sink top plate used in one embodiment of a heat sink according to the present invention;

FIG. 12 is a perspective view of the top plate shown in FIG. 11 with heat fins;

FIG. 13 is a perspective view of the top plate and fins in FIG. 12 with a bottom plate.

FIG. 14 is a graph showing the luminous intensity distribution of LED modules according to the present invention;

FIG. 15 is a graph showing the operating temperatures of LED modules and lighting fixtures according to the present invention;

FIG. 16 is the lumens per watt operating characteristics for an LED bulb and lighting fixture according to the present invention;

FIG. 17 is a sectional view of a light fixture according to the present invention;

FIG. 18 is a perspective view of another embodiment of a light fixture according to the present invention;

FIG. 19 are side views of lighting fixtures comparing conventional fixtures to two fixtures according to the present invention;

FIG. 20 are side views of different lighting fixtures comparing conventional fixtures to fixtures according to the present invention; and

FIG. 21 are side views of still different lighting fixtures comparing conventional fixtures to fixtures according to the present invention.

### DETAILED DESCRIPTION OF THE INVENTION

The present invention is directed to different embodiments of LED module structures that are efficient, reliable and cost effective, and provide an essentially omnidirectional emission pattern from directional LED light sources, such as forward emitting light sources. The different module structures can be used alone or in conjunction with a fixture to produce the desired emission. The present invention is also directed to lamp fixtures utilizing LED modules according to the present invention to provide for improved thermal management. The LED module and lighting fixture structures are arranged to provide for reliable and efficient light emission at elevated emission intensities, with some embodiments emitting from 800 to 1100 lumens or more in an omnidirectional emission pattern. This allows for the modules according to the present invention to be used for 60 and 75 W incandescent replacement applications, with some embodiments also being used for 100 W or higher replacements.

The LED module embodiments according to the present invention allow for operation at elevated power levels due in part to being arranged to or capable of cooperating with lighting fixture surfaces to provide improved thermal management. Instead of relying primarily on thermal dissipation through the module's heat sink, the LED modules according to the present invention take advantage of interfaces which are thermally conductive allowing the use of the features of the fixtures or luminaires (“fixtures”) in which they are mounted to increase surface area for heat dissipation. The LED module and/or fixtures can have conductive elements that allow heat to pass from the LED module to remaining portions of the fixture where the heat can dissipate into the ambient. The LED modules and/or fixtures can provide thermal interfaces that enable reduction of the overall module temperature compared to the module as a standalone, as a result of enabling efficient heat flow into the lamp fixture. These embodiments reduce or eliminate the thermal disadvantages provided by LED bulbs with traditional Edison sockets, and leverages the fixture and LED module lighting system to efficiently dissipate heat.

The LED modules according to the present invention are also arranged so that the power supply unit (“PSU”) is spatially and/or thermally isolated or remote to the module's LEDs. This can reduce or eliminate the thermal impact the module's LEDs have on the PSU elements, and vice versa, thereby allowing for both to operate at lower temperatures. The thermal and/or spatial separation from the module heat source (i.e. LED board) enables a lower operating temperature of the PSU and thereby the use of lower cost PSU components having a reduced temperature rating, while not sacrificing reliability.

The LED modules according to the present invention also can use efficient remote phosphor technology that allows for omnidirectional light distribution. In some embodiments the distribution is comparable to Energy Star requirements, while in other embodiments the emission characteristics can meet Energy Star requirements. The remote phosphor configurations according to the present invention also provide for good color point stability over time and for efficiency gains over lamps having phosphor applied directly onto the LED chip or into the LED component package. The LED modules according to the present invention can also be arranged to emit light with color consistency at different viewing angles with the color variations not exceeding those of seven standard deviations of color matching (SDCM). In some embodiments the color variation stays within a 4-step SDCM or less over the range of viewing angles.

The remote phosphor in the LED modules according to present invention can be a flat, two dimensional structure over and spaced apart from the module's LEDs. In other embodiments the remote phosphor can be a dome shaped (or frusto-spherical shaped) three dimensional conversion material over and spaced apart from the module's LEDs. For both, the remote phosphor can be arranged to include only phosphor or other down-conversion materials that sized to both convert and scatter light from the module's LEDs. In other embodiments the remote phosphors or down-converter element can contain a material for converting light from the module's LEDs and a diffusing (or scattering) material to scatter and mix the light for achieving an optimum intensity, distribution and color uniformity of the emitted light across the desired emission angles. Other embodiments can comprise a dome-shaped diffuser spaced apart from and over the remote phosphor. The spaces between the various structures can comprise light mixing chambers that can promote the dispersion of, and color uniformity of the lamp emission. Other embodiments can comprise additional conversion materials or diffusers that can form additional mixing chambers. These are only a few of the many different conversion material and diffuser arrangements according to the present invention.

Some lamp embodiments according to the present invention can comprise a light source having a co-planar arrangement of one or more LED chips or packages, with the emitters being mounted on a flat or planar surface such as a PCB. In other embodiments, the LED chips can be non co-planar, such as being on a pedestal or other three-dimensional structure. Other non-planar configurations may be seen in U.S. patent application Ser. No. 12/985,275, to Tong et al., entitled “LED Lamp With Active Cooling Element,” and U.S. patent application Ser. No. 13/250,289, to Yao, entitled “High Efficiency LEDs,” incorporated herein by reference. Co-planar light sources can reduce the complexity of the emitter arrangement, and can allow for chip on board mounting techniques, which can make the light sources both easier and cheaper to manufacture. Co-planar light sources, however, tend to emit primarily in the forward direction such as in a Lambertian emission pattern. In different embodiments it can be desirable to emit a light pattern mimicking that of conventional incandescent light modules that can provide a more omnidirectional intensity distribution and color uniformity. Different embodiments of the present invention can comprise features that can transform the directional emission pattern to a more omnidirectional emission pattern within a range of viewing angles.

Different embodiments of the LED modules can have many different shapes and sizes, with some embodiments having dimensions to fit into standard size envelopes, such as the standard A19 size envelope. This makes the modules particularly useful as replacements for conventional incandescent and compact fluorescent lamps (CFL) or bulbs, with modules according to the present invention experiencing the reduced energy consumption and long life provided from their solid state light sources. The lamps according to the present invention can also fit within the mechanical envelope of other types of standard size profiles including but not limited to A21 and A23.

In some embodiments the LED module according to the present invention can comprise one or more blue emitting LEDs in combination with one or more red emitting LEDs. The phosphor material in the remote converter element can comprise one or more materials that absorb a portion of the blue light and emit one or more different wavelengths of light. This allows the LED module to emit a white light combination from the blue LED, the red LED and phosphor. The light source can also comprise different LEDs and conversion materials emitting different colors of light so that the lamp emits light with the desired characteristics such as color temperature and color rendering. In some embodiments, the LED module can emit light with a correlated color temperature of approximately 2700K, with a color rendering index greater than 85.

Conventional lamps incorporating both red and blue LEDs can be subject to color instability with different operating temperatures and dimming. This can be due to the different behaviors of red and blue LEDs at different temperature and operating power (current/voltage), as well as different operating characteristics over time. This effect can be mitigated through the implementation of an active electronic control and compensation system. In some embodiments the control and compensation system can reside on the same circuit board as the LEDs, providing a compact and efficient lighting and compensation system.

The present invention is described herein with reference to certain embodiments, but it is understood that the invention can be embodied in many different forms and should not be construed as limited to the embodiments set forth herein. In particular, the present invention is described below in regards to certain lamps having one or multiple LEDs or LED chips or LED packages in different configurations, but it is understood that the present invention can be used for many other lamps having many different configurations. Examples of different lamps arranged in different ways according to the present invention are described below and in U.S. Provisional Patent application Ser. No. 61/435,759, to Le et al., entitled “Solid State Lamp”, filed on Jan. 24, 2011, and U.S. patent application Ser. No. 13/028,946, to Le et al., entitled “High Efficacy LED Lamp With Remote Phosphor and Diffuser Configuration”, both incorporated herein by reference.

The present invention may be described herein with reference to conversion materials, wavelength conversion materials, remote phosphors, phosphors, phosphor layers and related terms. The use of these terms should not be construed as limiting. It is understood that the use of the term remote phosphors, phosphor or phosphor layers is meant to encompass and be equally applicable to all wavelength conversion materials.

The embodiments below are described with reference to LED or LEDs, but it is understood that this is meant to encompass LED chips and LED packages. These components can have different shapes and sizes beyond those shown and different numbers of LEDs can be included. It is also understood that the embodiments described below utilize co-planar light sources, but it is understood that non co-planar light sources can also be used. It is also understood that the lamp's LED light source may be comprised of one or multiple LEDs, and in embodiments with more than one LED, the LEDs may have different emission wavelengths. Similarly, some LEDs may have adjacent or contacting phosphor layers or regions, while others may have either adjacent phosphor layers of different composition or no phosphor layer at all.

The present invention is also described in reference to lighting fixtures or luminares, but is it understood that the present invention is applicable to any arrangement utilizing a light module or lamp, and these terms should not be construed as limiting. The present invention is also described herein with reference to conversion materials, and remote phosphors and diffusers being remote to one another. Remote in this context refers being spaced apart from and/or to not being on or in direct thermal contact.

It is also understood that when an element such as a layer, region or substrate is referred to as being “on” another element, it can be directly on the other element or intervening elements may also be present. Furthermore, relative terms such as “inner”, “outer”, “upper”, “above”, “lower”, “beneath”, and “below”, and similar terms, may be used herein to describe a relationship of one layer or another region. It is understood that these terms are intended to encompass different orientations of the device in addition to the orientation depicted in the figures.

Although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Embodiments of the invention are described herein with reference to cross-sectional view illustrations that are schematic illustrations of embodiments of the invention. As such, the actual thickness of the layers can be different, and variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. A region illustrated or described as square or rectangular will typically have rounded or curved features due to normal manufacturing tolerances. Thus, the regions illustrated in the figures are schematic in nature and their shapes are not intended to illustrate the precise shape of a region of a device and are not intended to limit the scope of the invention.

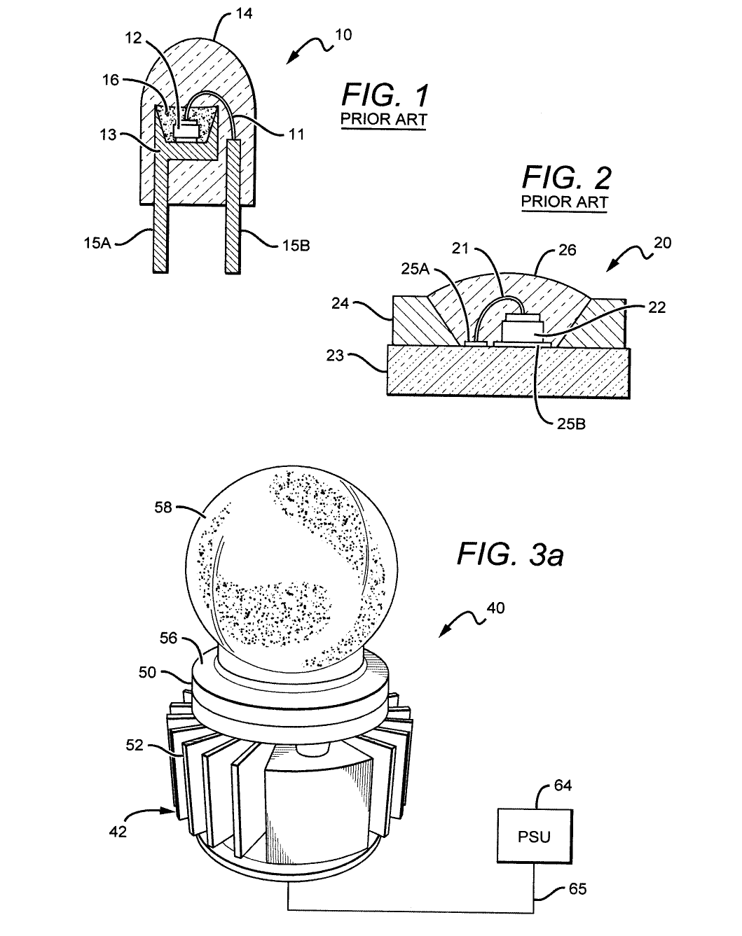

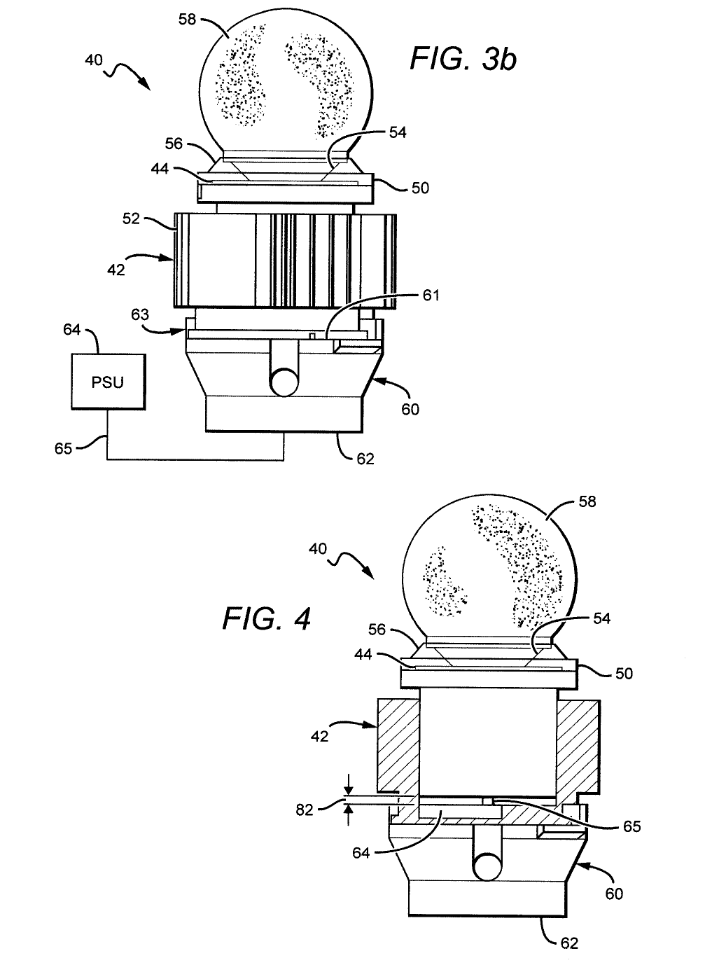

FIGS. 3 through 6 show one embodiment of an LED module 40 according to the present invention that comprises a heat sink 42, with a planar optical element 44 mounted to the top of the heat sink 42. Many different mechanical mounting methods can be used, such as screws, rivets, twist and lock arrangements, etc. Alternatively, bonding agents or adhesives can be used, some of which can be thermally conductive. The optical element 44 can comprise an array of LEDs 48 on its top surface, with the optical element 44 mounted to the bottom of a reflective collar 50 with the array of LEDs arranged in the opening of the collar 50. It is understood that in other embodiments the light source can comprise a single LED or LED package, and the optical module can comprise a three dimensional pedestal or other structure as described in U.S. patent application Ser. No. 12/848,825 to Tong et al., entitled “LED Based Pedestal-Type Lighting Structure,” also assigned to Cree and incorporated herein by reference.

Many different commercially available LED chips or LED packages can be used including but not limited to those commercially available from Cree, Inc. located in Durham, N.C. It is understood that lamp embodiments can be provided without a collar, with the LEDs mounted in different ways in these other embodiments. The optical element 44 can be mounted to the collar 50 using many different known mounting methods such mechanical or adhesive agents mentioned above.

The heat sink 42 can at least partially comprise a thermally conductive material, and many different thermally conductive materials can be used including different metals such as copper or aluminum, or metal alloys. Copper can have a thermal conductivity of up to 400 W/m-K or more. In some embodiments the heat sink can comprise high purity aluminum that can have a thermal conductivity at room temperature of approximately 210 W/m-K. In other embodiments the heat sink structure can comprise die cast aluminum having a thermal conductivity of approximately 100 W/m-K. The heat sink structure 42 can also comprise other heat dissipation features such as heat fins 52 that increase the surface area of the heat sink to facilitate more efficient dissipation into the ambient. In some embodiments, the heat fins 52 can be made of material with higher thermal conductivity than the remainder of the heat sink. In the embodiment shown the fins 52 are shown in a generally vertical orientation, but it is understood that in other embodiments the fins can have a vertical or angled orientation. Different heat dissipation arrangements and structures are described in U.S. patent application Ser. No. 13/022,490, to Tong et al., entitled “LED Lamp With Active Cooling Element”, and U.S. Patent Application Ser. No. 61/339,516, to Tong et al., entitled “LED Lamp Incorporating Remote Phosphor with Heat Dissipation Features and Diffuser Element,” also assigned to Cree, Inc., and U.S. patent application Ser. No. 13/029,025, to Tong et al., entitled “LED Lamp Incorporating Remote Phosphor With Heat Dissipation Features,” and incorporated herein by reference.

In some embodiments, the collar 50 can comprise a reflective material, or can have a reflective coating. With the remote phosphor arrangement of the present invention the high reflectivity of the collar and other mixing chamber surfaces may be essential in some configurations to achieve a high optical efficiency of the module by itself and the module combined with the fixtures. By being reflective, the collar 50 helps reflect light so that it can contribute to the overall emission of the LED module. The reflectivity of the collar and other mixing chamber surfaces should in some configurations be over 90% and in preferable configurations be ≧96%. Such a reflectivity can be achieved for example by coating the respective surfaces with titania (TiO2) loaded paint. In yet other configurations, most preferably the collar and/or cavity surfaces have a reflectivity of ≧98%. The collar 50 can comprise an inner angled reflective surface 54 arranged to reflect light emitted from the LEDs toward the collar to reflect in a direction that allows the light to emit from the module 40. The collar outer surface 56 can also be angled so that any module light emitted toward the outer surface 56 is reflected to contribute to overall module emission. It is understood that other embodiments can have collars with many different shapes and sizes, and in some embodiments can comprise a thermally conductive material. The collar 50 may be thermally conductive to allow efficient heat transfer from the planar optical element 44 to the heat sink 42, and further in some configurations from the remote phosphor 58 to the heat sink 42.

The LED module 40 also comprises remote phosphor 58 mounted to the collar 50, opposite the optical element 44, so that light from the optical element 44 passes through the remote phosphor. As mentioned above, the remote phosphor can be flat two dimensional shape, or can comprise a three dimensional shape. In the embodiment shown, the remote phosphor 58 comprises a globe with an opening at its base to allow light to enter from the optical element to enter.

In some embodiments, the remote phosphor 58 can be arranged to absorb some or all of the light from the optical element 44 and re-emit light at a different color, and can also have dispersing or scattering properties to disperse the light from the optical cavity. The remote phosphor can have only phosphor particles to absorb the optical element light and re-emit light at a different wavelength, with the phosphor particles being sized to also scatter the light. In other embodiments, a separate remote diffuser having scattering materials can also be included, such as over the remote phosphor. The remote phosphor and remote diffuser can both be dome shaped to provide a “double-dome” arrangement over the optical element 44. Different remote phosphor and diffuser arrangements are described in U.S. patent application Ser. No. 13/018,245 to Tong et al, entitled “LED Lamp With Remote Phosphor and Diffuser Configuration,” also assigned to Cree, Inc., and incorporated herein by reference. In still other embodiments, such as the embodiment shown, the remote phosphor 58 can comprise both the phosphor particles and scattering particles in the same element.

Certain phosphor particles can give the remote phosphor 58 a yellowish or orange color, and in the double dome arrangement the remote diffuser can have white color consistent with conventional incandescent bulbs. In double-dome embodiments where the diffuser is the outer most dome, the diffuser can mask the color of the remote phosphor. In embodiments where the color of the remote phosphor is not a concern, such as when the LED module is mounted in a light fixture having a shade that hides the module, it may not be as critical for the performance attributes or appearance acceptance of the module to mask the color of the remote phosphor. In these embodiments it may be acceptable to use a remote phosphor having a colored appearance.

It is understood that the remote phosphor 58 can be many different shapes and sizes depending at least partially on the light it receives from the optical element and the desired lamp emission pattern. The remote phosphor can also be mounted to the LED module using many different mounting methods. It is also understood that the remote phosphor 58 can cover less than the entire optical element 44. As further described below, in some embodiments the remote phosphor 58 can be arranged to disperse the light from the optical element 44 into an omnidirectional emission pattern.

The light conversion process of the phosphor particles generates heat in the remote phosphor. To help dissipate this heat, the remote phosphor can comprise phosphor particles in or on a thermally conductive light transmitting material, but it is understood that remote phosphors can also be provided that are not thermally conductive such as plastics or silicones. The thermally conductive material can comprise many different materials some of which have a thermal conductivity of greater than 0.5 W/m-K. Some examples of these materials include quartz (thermal conductivity 1.3 W/m-K), glass (thermal conductivity of 1.0-1.4 W/m-K) or sapphire (thermal conductivity of ˜40 W/m-K). In other embodiments, the thermally conductive material can have thermal conductivity greater than 1.0 W/m-K, while in other embodiments it can have thermal conductivity of greater than 5.0 W/m-K. In still other embodiments it can have a thermal conductivity of greater that 10 W/m-K. In some embodiments the carrier layer can have thermal conductivity ranging from 1.4 to 10 W/m-K. The remote phosphor can also have different thicknesses depending on the thermally conductive material being used, with a suitable range of thicknesses being 0.1 mm to 10 mm or more. The material should be thick enough to provide sufficient lateral heat spreading for the particular operating conditions. Generally, the higher the thermal conductivity of the material, the thinner the material can be while still providing the necessary thermal dissipation. Different factors can impact which carrier layer material is used including but not limited to cost and transparency to the light source light. Some materials may also be more suitable for larger diameters, such as plastic, glass or quartz.

The remote phosphor 58 can be mounted and/or bonded to the collar 50 using different known methods or materials such as thermally conductive bonding materials or a thermal grease. Conventional thermally conductive grease can contain ceramic materials such as beryllium oxide and aluminum nitride or metal particles such colloidal silver. In other embodiments the remote phosphor 58 can be mounted to the collar 50 using thermal conductive devices such as clamping mechanisms, screws, or thermal adhesive to hold the remote phosphor tightly to the collar 50 to maximize thermal conductivity.

Many different phosphors can be used in the remote phosphor 58 to generate the desired LED module light, with the present invention being particularly adapted to LED modules emitting white light. In some embodiments the optical element can be LEDs that emit light in the blue wavelength spectrum. The blue emitting LEDs can also be used in combination with LEDs emitting in other wavelength spectrums such as reds. The phosphor material in the remote phosphor 58 can absorb some of the blue light and re-emit yellow. This allows the lamp to emit a white light combination of blue and yellow light, and possibly other wavelengths of light. In some embodiments, the blue LED light can be converted by a commercially available YAG:Ce phosphor, although a full range of broad yellow spectral emission is possible using conversion particles made of phosphors based on the (Gd,Y)₃(Al,Ga)₅O₁₂:Ce system, such as the Y₃Al₅O₁₂:Ce (YAG). Other yellow phosphors that can be used include but is not limited to:

### Tb₃₋ₓREₓO₁₂:Ce(TAG); RE=Y, Gd, La, Lu; or

### Sr_{2-x-y}BaₓCa_{y}SiO₄:Eu.

The remote phosphor can also be arranged with more than one phosphor material either mixed or in separate layers. In some embodiments, each of the two phosphors can absorb the LED light and can re-emit different colors of light. In these embodiments, the colors from the two phosphor layers can be combined for higher CRI white of different white hue (warm white). This can include light from yellow phosphors above that can be combined with light from red phosphors. Different red phosphors can be used including:

SrₓCa₁₋ₓS:Eu, Y; Y=halide;

### CaSiAlN₃:Eu; or

### Sr_{2-y}Ca_{y}SiO₄:Eu

Other phosphors can be used to create color emission by converting substantially all light to a particular color. For example, the following phosphors can be used to generate green light:

### SrGa₂S₄:Eu;

### Sr_{2-y}Ba_{y}SiO₄:Eu; or

### SrSi₂O₂N₂:Eu.

The following lists some additional suitable phosphors used as conversion particles, although others can be used. Each exhibits excitation in the blue and/or UV emission spectrum, provides a desirable peak emission, has efficient light conversion, and has acceptable Stokes shift:

### YELLOW/GREEN

### (Sr,Ca,Ba)(Al,Ga)₂S₄:Eu²⁺

### Ba₂(Mg,Zn)Si₂O₇:Eu²⁺

### Gd_{0.46}Sr_{0.31}Al_{1.23}OₓF_{1.38}:Eu²⁺_{0.06}

### (Ba_{1-x-y}SrₓCa_{y})SiO₄:Eu

### Ba₂SiO₄:Eu²⁺

### RED

### Lu₂O₃:Eu³⁺

### (Sr₂₋ₓLaₓ)(Ce₁₋ₓEuₓ)O₄

### Sr₂Ce₁₋ₓEuₓO₄

### Sr₂₋ₓEuₓCeO₄

### SrTiO₃:Pr³⁺,Ga³⁺

### CaAlSiN₃:Eu²⁺

### Sr₂Si₅N₈:Eu²⁺

Different sized phosphor particles can be used including but not limited to particles in the range of 10 nanometers (nm) to 30 micrometers (μm), or larger. Smaller particle sizes typically scatter and mix colors better than larger sized particles to provide a more uniform light. Larger particles are typically more efficient at converting light compared to smaller particles, but emit a less uniform light. In some embodiments, the phosphor can be fixed on the remote phosphor in a binder, and the phosphor can also have different concentrations or loading of phosphor materials in the binder. A typical concentration being in a range of 30-70% by weight. In one embodiment, the phosphor concentration is approximately 65% by weight, and is preferably uniformly dispersed throughout the remote phosphor. The remote phosphor 58 can also have different regions with different concentrations of phosphor particles.

Alternate wavelength conversion materials may also be used to down-convert light to generate white emissions. Such materials may be, but are not limited to organic fluorescent materials or dyes or inorganic quantum dot materials such as CdSe/ZnS, InP/InAs, CdS/CdSe, CdTe/CdSe or others.

Different materials can be used for the binder, with materials preferably being robust after curing and substantially transparent in the visible wavelength spectrum. Suitable materials include silicones, epoxies, glass, inorganic glass, dielectrics, BCB, polymides, polymers and hybrids thereof, with the preferred material being silicone because of its high transparency and reliability in high power LEDs. Suitable phenyl- and methyl-based silicones are commercially available from Dow® Chemical. The binder can be cured using many different curing methods depending on different factors such as the type of binder used. Different curing methods include but are not limited to heat, ultraviolet (UV), infrared (IR) or air curing. It is understood, however, that the phosphor particles can be applied without a binder.

The phosphor and binder can be applied to the remote phosphor 58 using different processes including but not limited to spin coating, sputtering, printing, powder coating, electrophoretic deposition (EPD), and electrostatic deposition, among others. In still other embodiments, the phosphor and binder material can be separately fabricated and then mounted to the remote phosphor.

In one embodiment, a phosphor-binder mixture can be sprayed, poured or dispersed over the remote phosphor 58 with the binder then being cured. In some of these embodiments the phosphor-binder mixture can be sprayed, poured or dispersed onto or over the heated remote phosphor so that when the phosphor binder mixture contacts the remote phosphor 58, heat spreads into and cures the binder. These processes can also include a solvent in the phosphor-binder mixture that can liquefy and lower the viscosity of the mixture. Many different solvents can be used including but not limited to toluene, benzene, zylene, or OS-20 commercially available from Dow Corning®, and different concentration of the solvent can be used. When the solvent-phosphor-binder mixture is sprayed, poured or dispersed heat from the remote phosphor evaporates the solvent and can also cure the binder in the mixture leaving a fixed phosphor layer. Various deposition methods and systems are described in U.S. Patent Application Publication No. 2010/0155763, to Donofrio et al., entitled “Systems and Methods for Application of Optical Materials to Optical Elements,” and also assigned to Cree, Inc.

The phosphor can have many different thicknesses depending at least partially on the concentration of phosphor material and the desired amount of light to be converted by the remote phosphor. Phosphor according to the present invention can be applied in a binder with concentration levels (phosphor loading) above 30%. Other embodiments can have concentration levels above 50%, while in still others the concentration level can be above 60%. In some embodiments the phosphor binder combination can have thicknesses in the range of 10-100 microns, while in other embodiments it can have thicknesses in the range of 40-50 microns. Thickness may also vary across the layer.

The methods described above provide thickness control for the phosphor-binder layer to produce LED modules emitting within a single bin on the CIE chromaticity graph by controlling the amount of light source light converted by the remote phosphor. Binning is generally known in the art and is intended to ensure that the modules provided to the end customer emit light within an acceptable color range. White emitting modules can be sorted by chromaticity (color) and luminous flux (brightness). The methods described above can be also used to apply multiple layers of the same of different phosphor materials and different phosphor materials can be applied in different areas of the remote phosphor 58 using known masking processes.

When light from the optical element 44 is absorbed by the remote phosphor 58 it is re-emitted in isotropic directions, i.e. a portion of the light emits forward from the LED module 40 and a portion emits back toward the optical element 44. In prior lamps or modules with LEDs having conformal phosphor layers, a significant portion of the light emitted back can be directed back into the LED and its likelihood of escaping is limited by the extraction efficiency of the LED structure. For some LEDs the extraction efficiency can be approximately 70%, so a percentage of the light directed from the conversion material back into the LED can be lost. In the lamps according to the present invention having the remote phosphor configuration a higher percentage of the back emitted phosphor light strikes a surface of the collar 50 and the optical element 44, instead of the LEDs. Coating these surfaces with a reflective layer increases the percentage of light that reflects back into the remote phosphor 58 where it can emit from the lamp. These reflective layers allow for the collar 50 and optical element 44 to recycle photons, and increase the emission efficiency of the lamp. It is understood that the reflective layer can comprise many different materials and structures including but not limited to reflective metals, titania loaded paints or polymer coatings, or multiple layer reflective structures such as distributed Bragg reflectors. Reflective layers can also be included around the LEDs in those embodiments not having an optical cavity.

It is understood that the remote phosphors can be arranged in many different ways beyond the embodiment shown. The phosphor material can be on any surface of or can be mixed in with the thermally conductive material. The scattering materials can be mixed in with the phosphor or thermally conductive material and can also comprise scattering layers that can be included on the phosphor or the thermally conductive material. It is also understood that the phosphor and scattering layers can cover less than the entire surface of the thermally conductive material and in some embodiments the conversion layer and scattering layer can have different concentrations in different areas. It is also understood that the remote phosphor can have different roughened or shaped surfaces to enhance emission through the remote phosphor.

The scattering particles can comprise many different materials including but not limited to:

silica;

kaolin;

zinc oxide (ZnO);

yttrium oxide (Y₂O₃);

titanium dioxide (TiO₂);

barium sulfate (BaSO₄);

alumina (Al₂O₃);

fused silica (SiO₂);

fumed silica (SiO₂);

aluminum nitride;

glass beads;

zirconium dioxide (ZrO₂);

silicon carbide (SiC);

tantalum oxide (TaO₅);

silicon nitride (Si₃N₄);

niobium oxide (Nb₂O₅);

boron nitride (BN); or

phosphor particles (e.g., YAG:Ce, BOSE)

More than one scattering material in various combinations of materials or combinations of different forms of the same material may be used to achieve a particular scattering effect.

The present invention also comprises an electrical connection and thermal interface between the LED module 40 and the remainder of the light fixture that the LED module is mounted in. This not only allows for an electrical signal to be transmitted from the remote power supply unit to the LED module to cause it to emit light, but also allows heat generated by the LED module to spread to other surfaces outside of the module such as an external heat sink or surfaces of the light fixture. This increases the surface area available to dissipate the heat to the ambient, which in turn gives the overall lighting system the ability to dissipate greater amounts of heat. The thermal interface leverages the overall lighting system and its available light fixture heat dissipation features to provide for improved LED module thermal management.

In the embodiment shown, the LED module comprises a heat transfer adapter 60 (shown in FIGS. 3b-6) that is sized to be mounted in a desired light fixture. The adapter 60 can have many different shapes and sizes depending on the light fixture, and should be made of a thermally conductive material such as a metal. In some embodiments the adapter 60 can be made of aluminum, copper, or from thermally conductive composite materials or plastics. The adapter 60 should also be arranged such that the heat sink 42 can be mounted to the adapter's first surface 61, with the adapter's opposing second surface 62 arranged to be mounted in a light fixture. The heat sink 42 can be mounted to the adapter 60 using any of the mechanical and adhesive methods mentioned above, with embodiment shown mounted to the adapter 60 using a twist lock mechanism 63. In other configurations, the adapter 60 may be mounted to the collar with the heat sink 42 located on the second surface 62 of the adapter 60. In yet other configurations, the heat sink 42 may be a portion of the fixture the adapter 60 is being mounted to, or the heat sink 42 may be outside of the fixture.

The LED module 40 can have a much longer lifetime that conventional bulbs, and as a result it may not be necessary to have the LED module be removable from the fixture. The LED module can have a lifetime that matches or exceeds that of the light fixture. This extended lifetime can allow for the heat sink 42 to be mounted to the adapter using a more permanent mounting method, such as known rivet methods. In some embodiments, the adapter 60 can be integrated with the heat sink 42 for ease of manufacturing. For example, the heat sink 42 may comprise a flat base plate with screw holes that can be mounted to the lamp fixture.

It is also understood that the adapter 60 can be provided as part of the LED module 40, that is then mounted in the lamp fixture, or can be included as part of the lamp fixture with the remainder of the LED module 40 mounted to the adapter in the fixture. In either case, the combination of the module and fixture should include the adapter 60 arranged to conduct heat from the heat sink 42 to other portions of the fixture.

The LED module 40 according to the present invention can also comprise a PSU 64 that is spatially and/or thermally isolated or remote to the module's LEDs. As described above, this can reduce or eliminate the thermal impact the module's LEDs have on the PSU elements, and vice versa, thereby allowing for both to operate at lower temperatures. The PSU 64 can be housed in the light fixture itself in a location that eliminate or reduces the thermal cross-talk between the module's LEDs and the PSU 64, or the PSU 64 can be remote to the light fixture. For example, the PSU 64 can be housed in the base of a light fixture, or could be remote such as at the lights' wall switch. These are only a couple examples, and it is understood that the PSU 64 can be in many other locations according to the present invention.

The PSU 64 can be electrically coupled to the LED module and the optical unit 44 by electrical conductor 65 that can comprise many different conventional conductors, such as insulated wires, and can comprise different numbers of conductors. The conductor 65 may also have a similar structure to electrical connector 68. The drive signal from the remote PSU can be provided to the LED module 40, where it is transmitted through adapter 60 and the heat sink 42, to the optical element 44. Additional conductors can be included to provide feedback between the PSU 64 and the module 40 for control purposes. In still other embodiments, the fixture itself could be used to conduct an electrical signal from the PSU to the module. One such embodiment could comprise a low voltage power supply conducting its signal through the fixture.

FIG. 4 shows a cross section of an LED module 40 which incorporates a thermally insulated or remote PSU 64. The PSU 64 is insulated from the heat sink 42 and remainder of the module 40 by an area 82 which can either be an air gap or any other material which is not a good thermal conductor, such as a porous non-conducive material, for example a polymer foam. The PSU 64 is electrically connected to the optical element via conductor(s) 65. In other embodiments the PSU 64 may be placed in other locations insulated from the optical element 44 and/or heat sink by a similar gap 82, or the PSU may be physically remote as shown in FIG. 3b.

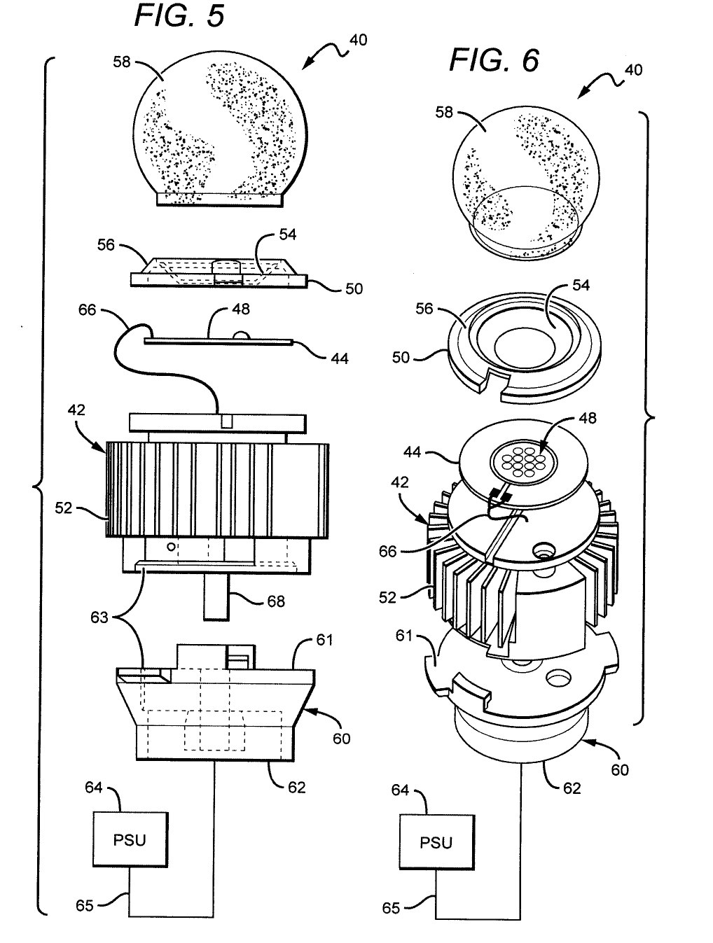

As shown in FIG. 5, the LED module 40 also comprises an electrical connector 68 to the LED optical element 44 that allows for an electrical signal applied to the adapter to be transmitted to the optical element 44. Many different connectors can be used, with the embodiment shown being a commercially available RCA jack connector. Many different connector sizes can be used, with the embodiment shown being a 3.5 mm RCA jack. The adapter 60 can have one side of the connector (e.g. female portion) and the heat sink 42 can have the other side of the connector (e.g. male portion), with an electrical signal provided to the adapter's female portion. When the heat sink 42 is mounted to the adapter 60, the heat sink's male portion plugs into the adapter's female portion so that the electrical signal at the female portion is conducted to the male portion. In some configurations, a similar connector may be used to connect the LED module 40 to a light fixture.

In the embodiment shown and as best shown in FIGS. 5 and 6, the conductor 65 passes through a central hole in the adapter 60, where it is coupled to the adapter's portion of the connector (male or female). An internal conductor 66 such as an insulated wire, has one end coupled to the connector portion in the heat sink 42 and the other end coupled to the optical element 44 to conduct a signal from the heat sink's connector portion to the optical element. When the heat sink 42 is mounted to the adapter 60, a continuous electrical path is formed between the PSU 64 and the optical element 44.

It is understood that many different connectors can be used. In some embodiments the heat sink can comprise a connector of the type to fit in conventional electrical receptacles. For example, it can include a feature for mounting to a standard Edison socket, which can comprise a screw-threaded portion which can be screwed into an Edison socket. In other embodiments, it can include a standard plug and the electrical receptacle can be a standard outlet, or can comprise a GU24 base unit, or it can be a clip and the electrical receptacle can be a receptacle which receives and retains the clip (e.g., as used in many fluorescent lights). In other embodiments, the connector can be a very simple arrangement such as two or more conducting leads that pass through corresponding holes in the heat sink and adapter and connect to the remote PSU. These are only a few of the options for heat sink and its connectors, and other arrangements can also be used that safely deliver electricity to the optical element 44.

In some configurations, the PSU 64 is both spatially and thermally remote or isolated from the LED module 40. In some embodiments, the PSU can be located in different areas of the lamp fixture, or can be remote to the fixture itself. By having the PSU thermally isolated from the LED module, heat from the LEDs on the optical element 44 does not spread to the PSU and vice versa. This can reduce the thermal stress imposed by this thermal cross talk, thereby increasing the lifetime and reliability of both. This also allows for the PSU to operate at a lower temperature such that it can be provided at a lower cost with lower temperature rated components. A remote PSU can also be arranged to switch between LED module light distribution intensities, such as between 800 and 1,100 lumens or higher.

In some embodiments of the LED modules according to the present invention the remote PSU or power conversion unit can comprise a driver to allow the module to run from an AC line voltage/current and to provide light source dimming capabilities. In some embodiments, the power supply can comprise an offline constant-current LED driver using a non-isolated quasi-resonant flyback topology. In these embodiments, the LED driver can fit within the lamp fixture and in some embodiments can comprise a less than 25 cubic centimeter volume, while in other embodiments it can comprise an approximately 20 cubic centimeter volume. It is understood that the power supply used can have different topology or geometry and can be dimmable as well.

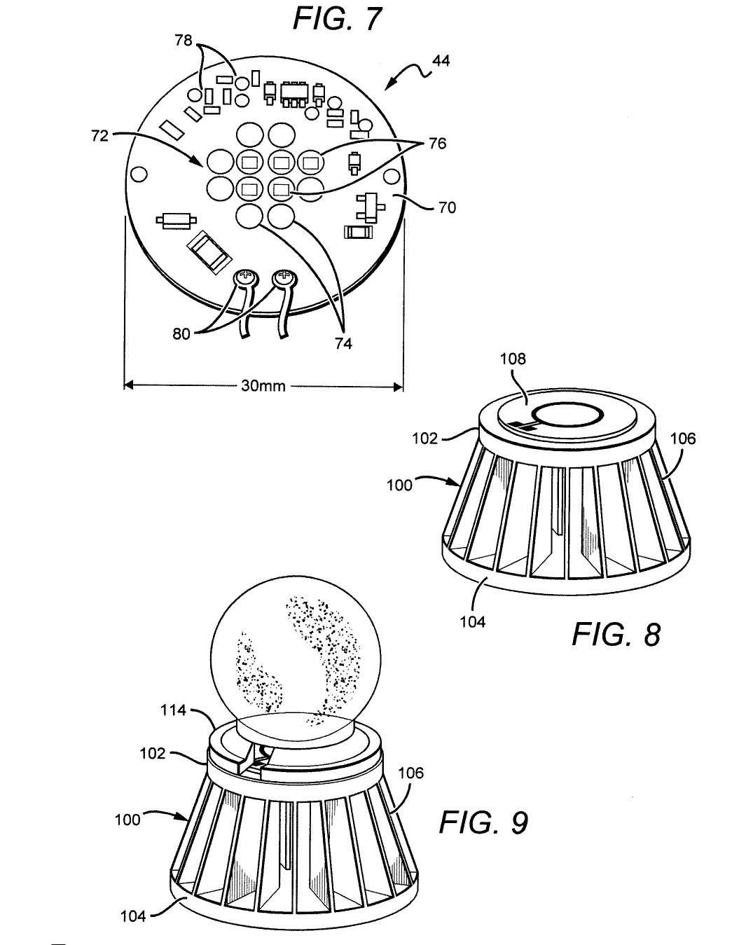

FIG. 7 shows one embodiment of an optical element 44 according to the present invention, which comprises a printed circuit board (PCB) 70 and an LED array 72. The LED array comprises chip-on-board mounting, with the chip die being mounted directly to the PCB 70 and lenses molded directly over the LEDs. This can allow for a number of advantages, including allowing for the LED chips to be mounted closer together compared to using pre-fabricated LED packages. This allows for a smaller form factor for the optical element 44. In some embodiments, the PCB 70 may further include secondary optics over the molded lenses and LEDs such as those shown in U.S. patent application Ser. No. 13/177,415, to Bhat et al, entitled “Compact Optically Efficient Solid State Light Source With Integrated Thermal Management”, and incorporated herein by reference.

Different LED module embodiments can comprise LED arrays having many different numbers of LEDs, some of which can emit different wavelengths of light. In the embodiment shown, the LED array 72 comprises twelve (12) LEDs, including seven (7) blue emitting LEDs 74 and five (5) red emitting LEDs 76. Many different commercially available blue emitting LEDs can be used, such as EZ1400 blue emitting LED commercially available from Cree®, Inc. The optical element 44 can also use commercially available AlInGap red emitting LEDs. The optical element 44 can be used with a remote phosphor that converts primarily the light from the blue phosphor, with the remote phosphor having yellow and/or red-orange phosphors.

In some embodiments, the LEDs emitting different colors of light can have emission characteristics that change in different ways in response to temperature and over time. In the embodiment shown, the red emitting LEDs emission characteristics can change in response to temperature and over time in a way different from the blue LEDs. As a result, an emission compensation circuit can be included in the LED module to compensate for the different emission characteristics. The compensation circuit, whose reliability is less sensitive to heat and mainly comprises passive components, can be included in any location either integral to or remote to the LED module. In the embodiment shown, a compensation circuit 78 is provided as part of the optical element 44, with the components of the compensation circuit mounted directly to the PCB 70. In the embodiment shown, the circuit is on the top surface of the PCB 70, with components around the LED array 72. An advantage of this arrangement is the local temperature can be measured and used as feedback for the compensation circuit without additional wires. However, it is understood that the circuit can be at other locations on the PCB 70, such as its bottom surface. The optical element also comprises electrical connection points 80 that allow for an electrical signal to be applied to the PCB 70. A reflective layer (not shown) can be included over the components of the compensation circuit 78 and the connection points 80, to minimize absorption of light by these elements.

Many different heat sink designs are used in conventional LED modules. In many cases, the heat sink comprises a solid core, wherein resides the integrated PSU and other electrical circuitry, with fins that have a vertical out edge, or have an outer edge that tapers in moving down the heat sink. One disadvantage of a solid core structure is that the core blocks air flow through the heat sink. The best convective heat transfer occurs when the fins of the heat sink are aligned with the direction of buoyancy flow, which is typically vertical. As a result, heat dissipation performance of LED modules with integrated PSUs can be highly dependent upon the orientation of the LED module and its heat sink. The convective performance of the heat sink fins is better when the fins are aligned in the vertical direction than when the fins are aligned in other directions. Horizontal orientation can often be the worst case where it is difficult for buoyancy flow to go across the fins and the solid core. This deficiency can limit the reliability of the LED module in certain applications, or require additional cost and weight be added to the module design to compensate for this deficiency. The shape and size of the heat sink should be arranged such that it does not block or interfere with the desired light output profile.

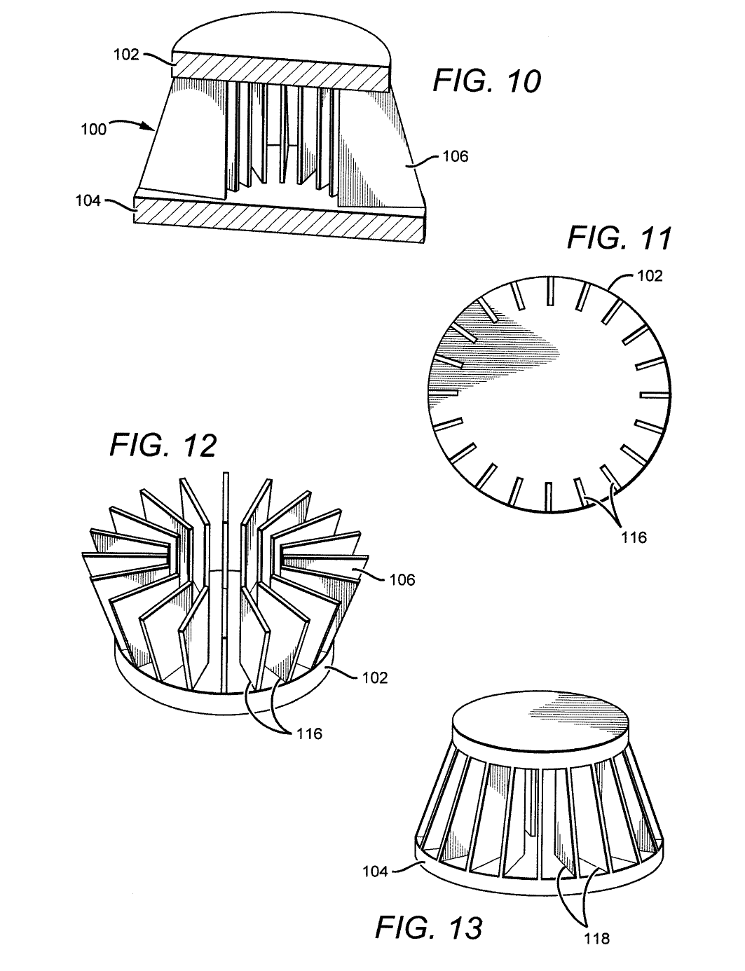

FIGS. 8-10 show one embodiment of a heat sink 100 according to the present invention that can be used in many different applications, but is particularly applicable to the LED modules described above, wherein the PSU is remote. The heat sink primarily comprises a top plate 102, and bottom metal plate 104, and heat fins 106 that connect the top plate 102 to the bottom metal plate 104. As shown in FIG. 8, optical element 108 can be mounted on the top plate 102 and can function as a heat spreader to laterally spread heat generated by the LEDs on the optical element 108. The bottom plate 104 can function as a mechanical, thermal and/or electrical interface to a light fixture, either directly or through an adapter as described above. The top and bottom plate 102, 104 can include one or more holes (not shown) to allow for electrical connections to pass from the light fixture to the optical element 108 as described above, and also to allow for better air flow through the plates. Between the top and bottom plate 102, 104 a number of metal fins are provided that can be arranged vertically and distributed with radial symmetry. The fins 106 can dissipate heat to the ambient by natural convection and can carry heat from the top plate 102 to the bottom plate 104. Due to the open core and the cage like structure of the heat sink 100, air flow can more pass around the fins 106 and carry away heat by natural convention. The convective heat dissipation is also less sensitive to the orientation of the LED module due to the hollow core of the heat sink. Referring now to FIG. 9, a remote phosphor can also be mounted to the top plate 102, with a collar 114 as described above.

In the embodiment shown, the fins 106 also taper out as moving down the heat sink 100, which increases both the surface area of the fins 106 and the bottom plate 104 compared to heat sinks with edges that are vertical or taper in. This provides for both increased fin and bottom plate surface area to conduct and dissipate heat from the optical element. The tapering out shape of the heat sink can also result in a top plate having a smaller diameter, which can reduce the amount of light that is blocked by the top plate. This can increase the amount of down emitted light in the viewing angle range of greater than 90°. However, it is understood that many different fin design and plate arrangements can be used.

The heat sinks according to the present invention can also be manufactured using simpler and less expensive processes. Referring now to FIGS. 11-13, in some embodiments the fins 106 can be stamped and press fit into the top and bottom plates 102, 104 thereby eliminating the need for a center core to mechanically support the fins. FIG. 11 shows a top plate 102 with top slots 116 for the fins, with FIG. 12 showing the fins 106 press fit into to the slots 116. FIG. 13 shows the bottom plate 104 that also has bottom slots 118, with the fins press fit in the bottom slots 118 to form the open core heat sink. This overall fabrication process is simpler and potentially cheaper in high volume compared to conventional heat sinks that can be formed by die casting or extrusion processes. By not having a center core, the heat sink 100 is also lighter in weight compared to other solid core heat sinks and can also require less materials to fabricate.

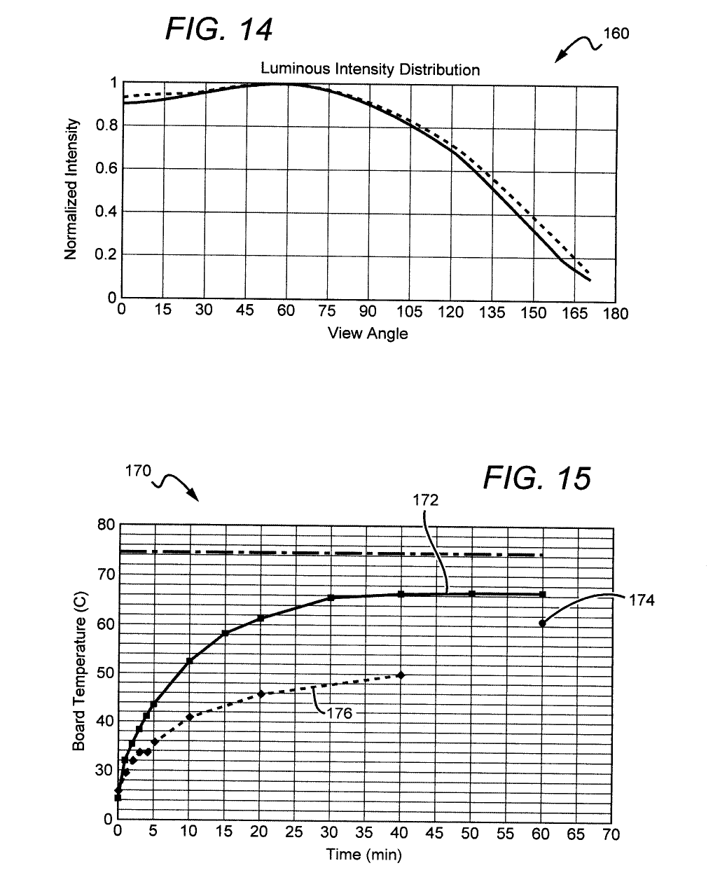

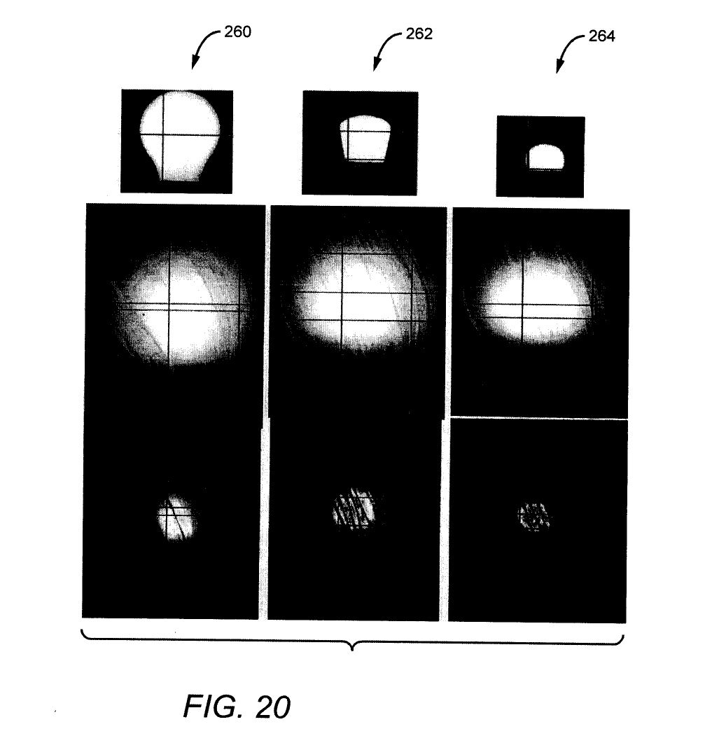

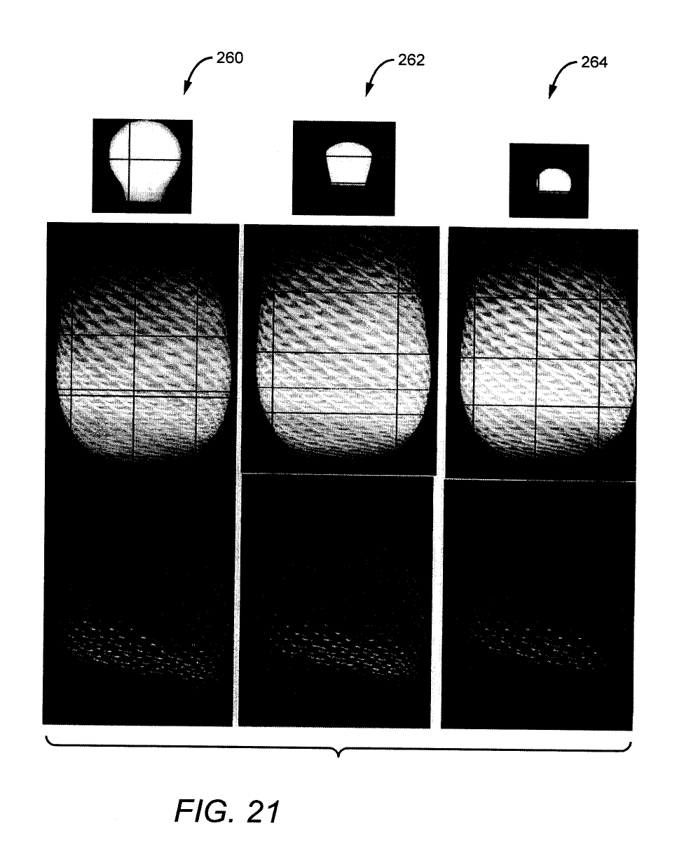

The different LED modules according to the present invention can emit different light patterns, with some embodiments emitting light omnidirectionally. FIG. 14 is a graph 160 showing the emission characteristics of two LED modules according to the present invention. The graph 160 shows light emission in the 0-90° viewing angle range, as well as emission in the 90-180° range. Different percentages of the overall emission can be in these different viewing angle ranges and in one embodiment 60% of the light is directed in the 0-90° range, with 40% of the light being in the 90-180° range. Energy Star requirements for omnidirectional LED lamps gauge the evenness of LED system emission modules based on the ratio of the intensity at any angle versus the minimum: average intensity over the 0-150° range. To pass the Energy Star rating the intensity at any angle in the 0-150° range should not deviate versus the median intensity in the same range by more than ±10%. The light distribution for some embodiments of the LED modules can have a minimum: average ratio in the range of 35-42%, while in other embodiment the light distribution can be 50% or higher. A key aspect of some configurations of the present disclosure include that despite this difference from the Energy Star intensity distribution the module may perform in fixture embodiments shown for example in FIG. 17-21 equivalent to lamps that by themselves meet the Energy Star evenness criteria.

FIG. 15 shows a graph 170 showing the operating temperature of different elements and fixtures according to the present invention. Plot 172 shows the operating temperature over time for a stand-alone LED module according to the present invention. Plot 174 shows the operating temperature at 60 minutes for light fixture according to the present invention with a shade. Plot 176 shows that operating temperature of a fixture according to the present invention with no shade. All operated well below 75° C. with the operating temperature of the fixtures being well below that of the stand-alone module.

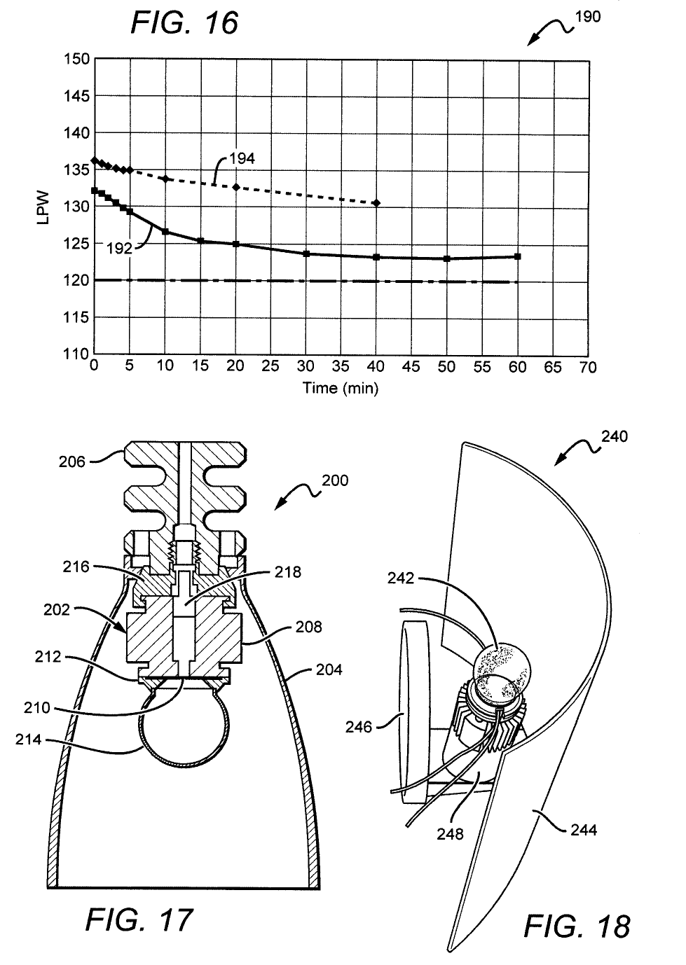

FIG. 16 shows a graph 190 the lumens per watt operating characteristics. Plot 192 shows the operating characteristics for a stand-alone optical element, while plot 194 shows the improved operating characteristics for a fixture according to the present invention. Both exhibited operation above 120 lumens per watt over time.

FIG. 17 shows one embodiment of a light fixture 200 and utilizing LED module 202 according to the present invention. Fixture 200 comprises a shade or housing 204 that surrounds the LED module 202 but has an opening at one end for light to escape. A fixture base 206 is mounted to the other end of the shade 204. The molded base 206 has an axial opening to allow a conductor to pass for applying an electrical signal to the LED module 202 from a remote PSU (not shown). Like the embodiment described above, the LED module 202 comprises a heat sink 208, an optical element 210, a collar 212, a three dimensional globe shaped remote phosphor 214, and a heat transfer adapter 216. The heat sink 208 comprises a jack 218 similar to the one described above to connect with a mating portion in the adapter 216 as described above. The adapter 216 is mounted to the base 206 with mating surfaces that allows heat transfer between the two. This allows for heat to spread from the heat sink 208, to the adapter 216, and to the base 206. Some heat can also spread to the shade 204. This heat spreading arrangement utilizes the features of the fixture 200 to assist in heat dissipation. This allows for improved thermal management of the heat generated by the optical element 210. This can allow for the use of smaller less expensive heat sinks or can allow for larger heat sinks can allow for the operation of the LEDs at a higher drive current.

FIG. 18 shows another embodiment of a light fixture 240 according to the present invention that is adapted for wall mounting and comprises a LED module 242 and a half shade 244. The fixture 240 further comprises a base 246 for mounting to a wall, with the base mounted to the LED module at its adapter 248. Like the embodiments above, the fixture heat spreads to the base 246 through the adapter 248 to help heat generated by the LEDs on the optical element, allowing the LEDs to operate at a lower temperature.

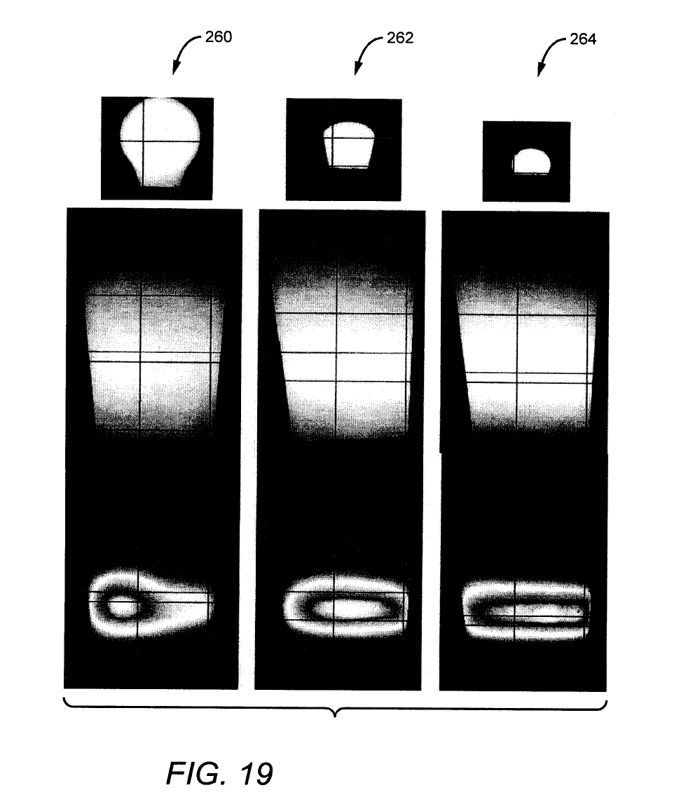

FIGS. 19, 20 and 21 show the light emission characteristics of three different types of lamp fixture having an incandescent module as its light source in the first column 260, compared to the emission characteristics for first and second LED modules 262, 264 according to the present invention, having two differently shaped remote phosphors. The LED modules used in this comparison did not meet the Energy Star emission standards, but when used in a light fixture provided overall fixture emission characteristics similar to the incandescent module which meets Energy Star. This illustrates that less expensive, non Energy Star LED modules can be used as replacements for incandescent modules in light fixture, while producing the same or similar fixture emission. In addition, it illustrates that an exact incandescent bulb form factor is not required to create a fixture with emissions meeting Energy Star requirements. Rather, LED modules with much smaller form factors, using a thermally conductive adapter to utilize areas outside the module for thermal dissipation, may be placed within systems or fixtures creating an emission pattern which meets the Energy Star standards.

Although the present invention has been described in detail with reference to certain preferred configurations thereof, other versions are possible. The invention can be used in any light fixtures where a uniform light or a near uniform light source is required. In other embodiments, the light intensity distribution of the LED module can be tailored to the particular fixture to produce the desired fixture emission pattern. Therefore, the spirit and scope of the invention should not be limited to the versions described above.

We claim:

1. A lighting module, comprising:
an optical element on a heat sink;
a wavelength conversion material on said heat sink and spaced from the optical element, wherein said module is arranged to be capable of connecting to a fixture via a connection adapter, the connection adapter being thermally and electrically conductive; and
a thermally remote power supply unit (PSU).

2. The lighting module of claim 1, further comprising a diffuser on said heat sink and spaced apart from said optical element.

3. The lighting module of claim 1, in which the optical element is placed on a thermally conductive collar which is on the heat sink.

4. The lighting module of claim 1, in which the optical element comprises a circuit board with at least a light emitting diode (LED).

5. The lighting module of claim 4, further comprising an electronic compensation circuit mounted to the circuit board.

6. The lighting module of claim 1, emitting an emission pattern that complies with the ENERGY STAR® requirements.

7. The lighting module of claim 1, emitting an emission profile equivalent to fixtures with omnidirectional ENERGY STAR® compliant lamps, when the module is placed within the fixture, in which the fixture comprises fixture level diffusion or scattering elements.

8. The lighting module of claim 4, wherein the at least one LED is mounted directly on the circuit board.

9. The lighting module of claim 1, wherein said wavelength conversion material comprises a wavelength converter carrier having a thermally conductive material.

10. The lighting module of claim 2, wherein said diffuser comprises a diffuser dome.

11. The lighting module of claim 2, wherein said diffuser comprises a diffusing material, wherein said diffuser has one or more areas covered by a greater amount of diffusing material.

12. The lighting module of claim 2, wherein said diffuser disperses light from said optical element and/or said wavelength conversion material.

13. The lighting module of claim 1, wherein said wavelength conversion material is three-dimensional.

14. The lighting module of claim 1, wherein said wavelength conversion material is planar.

15. The lighting module of claim 1, wherein said wavelength conversion material is substantially frusto-spherical.

16. The lighting module of claim 2, wherein said diffuser is substantially frusto-spherical.

17. The lighting module of claim 2, wherein said wavelength conversion material and said diffuser are substantially frusto-spherical such that said wavelength conversion material phosphor and diffuser provide a double-dome structure.

18. The lighting module of claim 2, wherein said diffuser at least partially conceals the appearance of said wavelength conversion material when said lighting module is not operating.

19. The lighting module of claim 18, wherein said diffuser exhibits a white appearance when said lighting module is not operating.

20. The lighting module of claim 1, in which the thermally remote PSU is separate from the heat sink by an air gap.

21. The lighting module of claim 1, in which the thermally remote PSU is separate from the heat sink by a non-conductive porous material.

22. The lighting module of claim 1, in which the optical element is non-planar.

23. The lighting module of claims 1, providing a steady state lumen output of at least 800 lumens.

24. The lighting module of claim 1, providing a steady state lumen output of 65 lumens per watt or more.

25. The lighting module of claim 1, providing a steady state lumen output of 80 lumens per watt or more.

26. The lighting module of claim 25, operating from less than 10 watts.

27. The lighting module of claim 1, providing a steady state output of 800 lumens at 10 watts or less.

28. The lighting module of claim 1, wherein light emitted from the lighting module has an even spatial intensity distribution in a range of viewing angles from 0 to 135° with the intensity differing ≦50% from the mean intensity within that range.

29. The lighting module of claim 1, wherein light emitted from the lighting module has an even spatial intensity uniformity in a range of viewing angles from 0 to 135° with the intensity differing ≦30% from the mean intensity within that range.

30. The lighting module of claim 28, having greater than 5% of total luminous flux in the 135 to 180° viewing angles.

31. The lighting module of claim 1, in which the PSU is physically remote from the lighting module.

32. The lighting module of claim 1, in which the module is connected to a fixture and is capable of dissipating heat from said module through said connection adapter to said fixture.

33. The lighting module of claim 3, in which the conductive collar comprises a reflective surface with at least 96% reflectivity.

34. A lighting module, comprising:
an optical element on a heat sink;
an electronic compensation circuit on said optical element;
an electrically and thermally conductive connection adapter on the lighting module allowing the lighting module to be capable of connecting to a fixture; and
a wavelength conversion material over said optical element.

35. The lighting module of claim 34, further comprising a diffuser on said heat sink and spaced apart from said optical element.

36. The lighting module of claim 34, in which the optical element is placed on a thermally conductive collar which is on the heat sink.

37. The lighting module of claim 34, in which the optical element comprises a circuit board with at least one light emitting diode (LED).

38. The lighting module of claim 37, in which the electronic compensation circuit is mounted to the circuit board.

39. The lighting module of claim 34, emitting an emission pattern that complies with the ENERGY STAR® requirements.

40. The lighting module of claim 34, emitting an emission profile equivalent to fixtures with omnidirectional ENERGY STAR® compliant lamps, when the module is placed within the fixture, such that the fixture comprises fixture level diffusion or scattering elements.

41. The lighting module of claim 37, wherein the at least one LED is mounted directly on the circuit board.

42. The lighting module of claim 34, wherein said wavelength conversion material comprises a wavelength converter carrier having a thermally conductive material.

43. The lighting module of claim 35, wherein said diffuser comprises a diffuser dome.

44. The lighting module of claim 35, wherein said diffuser comprises a diffusing material, wherein said diffuser has one or more areas covered by a greater amount of diffusing material.

45. The lighting module of claim 35, wherein said diffuser disperses light from said optical element and/or said wavelength conversion material.

46. The lighting module of claim 34, wherein said wavelength conversion material is three-dimensional.

47. The lighting module of claim 34, wherein said wavelength conversion material is planar.

48. The lighting module of claim 34, wherein said wavelength conversion material is substantially frusto-spherical.

49. The lighting module of claim 35, wherein said diffuser is substantially frusto-spherical.

50. The lighting module of claim 35, wherein said wavelength conversion material and said diffuser are substantially frusto-spherical such that said wavelength conversion material phosphor and diffuser provide a double-dome structure.

51. The lighting module of claim 35, wherein said diffuser at least partially conceals the appearance of said wavelength conversion material when said lighting module is not operating.

52. The lighting module of claim 34, further comprising a thermally remote PSU.

53. The lighting module of claim 52, in which the thermally remote PSU is separate from the heat sink by a non-conductive porous material.

54. The lighting module of claim 52, in which the thermally remote PSU is separate from the heat sink by an air gap.

55. The lighting module of claim 34, further comprising a physically remote PSU.

56. The lighting module of claim 34, in which the optical element is non-planar.

57. The lighting module of claims 34, providing a steady state lumen output of at least 800 lumens.

58. The lighting module of claim 34, providing a steady state lumen output of 65 lumens per watt or more.

59. The lighting module of claim 34, providing a steady state lumen output of 80 lumens per watt or more.

60. The lighting module of claim 59, operating from less than 10 watts.

61. The lighting module of claim 34, wherein light emitted from the lighting module has an even spatial intensity distribution in a range of viewing angles from 0 to 135° with the intensity differing ≦50% from the mean intensity within that range.

62. The lighting module of claim 34, wherein light emitted from the lighting module has an even spatial intensity uniformity in a range of viewing angles from 0 to 135° with the intensity differing ≦30% from the mean intensity within that range.

63. The lighting module of claim 61, having greater than 5% of total luminous flux in the 135 to 180° viewing angles.

64. The lighting module of claim 34, in which the module is connected to a fixture and is capable of dissipating heat from said module through said connection adapter to said fixture.

65. The lighting module of claim 36, in which the conductive collar comprises a reflective surface with at least 96% reflectivity.

66. A lighting module, comprising:
an optical element on a heat sink, the heat sink comprising a plurality of heat fins;
a conductive connection adapter on the lighting module allowing the lighting module to be capable of connecting to a fixture;
a remote PSU; and
a remote wavelength conversion material over said optical element, wherein the module is arranged to have a substantially uniform emission pattern.

67. The lighting module of claim 66, in which the plurality of heat fins each having a lower angled portion that angles out from the central axis of said lighting device, and an upper portion that angles back toward said central axis.

68. The lighting module of claim 66, further comprising a diffuser on said heat sink and spaced apart from said optical element.

69. The lighting module of claim 66, in which the optical element is placed on a thermally conductive collar which is on the heat sink.

70. The lighting module of claim 66, in which the optical element comprises a circuit board with at least one light emitting diode (LED).

71. The lighting module of claim 70, further comprising an electronic compensation circuit mounted to the circuit board.

72. The lighting module of claim 66, emitting an emission pattern that complies with the ENERGY STAR® requirements.

73. The lighting module of claim 66, emitting an emission profile equivalent to fixtures with omnidirectional ENERGY STAR® compliant lamps, when the module is placed within the fixture, such that the fixture comprises fixture level diffusion or scattering elements.

74. The lighting module of claim 68, in which the diffuser comprises a diffuser dome and said heat fins do not extend beyond outer lateral edge of said diffuser dome.

75. The lighting module of claim 70, wherein the at least one LED is mounted directly on the circuit board.

76. The lighting module of claim 66, wherein said wavelength conversion material comprises a wavelength converter carrier having a thermally conductive material.

77. The lighting module of claim 68, wherein said diffuser comprises a diffuser dome.

78. The lighting module of claim 68, wherein said diffuser disperses light from said optical element and/or said wavelength conversion material.

79. The lighting module of claim 66, wherein said wavelength conversion material is three-dimensional.

80. The lighting module of claim 66, wherein said wavelength conversion material is planar.

81. The lighting module of claim 66, wherein said wavelength conversion material is substantially frusto-spherical.

82. The lighting module of claim 68, wherein said diffuser is substantially frusto-spherical.

83. The lighting module of claim 68, wherein said wavelength conversion material and said diffuser are substantially frusto-spherical such that said wavelength conversion material phosphor and diffuser provide a double-dome structure.

84. The lighting module of claim 68, wherein said diffuser at least partially conceals the appearance of said wavelength conversion material when said lighting module is not operating.

85. The lighting module of claim 66, in which the remote PSU is thermally separated from the heat sink by an air gap.

86. The lighting module of claim 66, in which the remote PSU is thermally separated from the heat sink by a non-conductive porous material.

87. The lighting module of claim 66, in which the optical element is non-planar.

88. The lighting module of claims 66, providing a steady state lumen output of at least 800 lumens.

89. The lighting module of claim 66, providing a steady state lumen output of 65 lumens per watt or more.

90. The lighting module of claim 66, providing a steady state lumen output of 80 lumens per watt or more.

91. The lighting module of claim 90, operating from less than 10 watts.

92. The lighting module of claim 66, wherein light emitted from the lighting module has an even spatial intensity uniformity in a range of viewing angles from 0 to 135° with the intensity differing ≦50% from the mean intensity within that range.

93. The lighting module of claim 66, wherein light emitted from the lighting module has an even spatial intensity uniformity in a range of viewing angles from 0 to 135° with the intensity differing ≦30% from the mean intensity within that range.

94. The lighting module of claim 92, having greater than 5% of total luminous flux in the 135 to 180° viewing angles.

95. The lighting module of claim 66, in which the PSU is physically remote from the lighting module and electrically connected through a conductor.

96. The lighting module of claim 66, in which the module is connected to a fixture and is capable of dissipating heat from said module through said connection adapter to said fixture.

97. The lighting module of claim 69, in which the conductive collar comprises a reflective surface with at least 96% reflectivity.

98. A lighting fixture, comprising:
an outer fixture housing; and
a lighting module comprising:
an optical element on a heat sink;
a wavelength conversion material on said heat sink and spaced from the optical element;
a thermally and electrically conductive connection adapter, capable of connecting the module to the outer fixture housing; and
a thermally remote power supply unit (PSU).

99. The lighting fixture of claim 98, further comprising a diffuser on said heat sink and spaced apart from said optical element.

100. The lighting fixture of claim 98, further comprising a fixture level diffuser or scattering element.

101. The lighting fixture of claim 98, in which the optical element is placed on a conductive collar which is on the heat sink.

102. The lighting fixture of claim 98, in which the optical element comprises a circuit board with at least one light emitting diode (LED).

103. The lighting fixture of claim 102, further comprising an electronic compensation circuit mounted to the circuit board.

104. The lighting fixture of claim 98, emitting an emission pattern that complies with the ENERGY STAR® requirements.

105. The lighting fixture of claim 102, wherein the at least one LED is mounted directly on the circuit board.

106. The lighting fixture of claim 98, wherein said wavelength conversion material comprises a wavelength conversion carrier having a thermally conductive material.

107. The lighting fixture of claim 99, wherein said diffuser comprises a diffuser dome.

108. The lighting fixture of claim 99, wherein said diffuser disperses light from said optical element and/or said wavelength conversion material.

109. The lighting fixture of claim 98, wherein said wavelength conversion material is three-dimensional.

110. The lighting fixture of claim 98, wherein said wavelength conversion material is planar.

111. The lighting fixture of claim 99, wherein said wavelength conversion material and said diffuser are substantially frusto-spherical such that said wavelength conversion material phosphor and diffuser provide a double-dome structure.

112. The lighting fixture of claim 99, wherein said diffuser at least partially conceals the appearance of said wavelength conversion material when said lighting module is not operating.

113. The lighting fixture of claim 98, in which the optical element is non-planar.

114. The lighting fixture of claims 98, providing a steady state lumen output of at least 800 lumens.

115. The lighting fixture of claim 98, providing a steady state lumen output of 65 lumens per watt or more.

116. The lighting fixture of claim 98, providing a steady state lumen output of 80 lumens per watt or more.

117. The lighting fixture of claim 116, operating from less than 10 watts.

118. The lighting fixture of claim 98, in which the PSU is physically remote from the lighting module.

119. The lighting fixture of claim 98, in which the module is capable of dissipating heat from said module through said connection adapter to said fixture.

120. The lighting fixture of claim 98, in which the optical element emits light with an efficacy of 80 lumens per watt or more, and having a lifetime of greater than 25,000 hours or more.

121. The lighting fixture of claim 98, in which the optical element emits light with an efficacy of 80 lumens per watt or more, and having a lifetime of 50,000 hours or more.

122. The lighting fixture of claim 101, in which the conductive collar comprises a reflective surface with at least 96% reflectivity.

123. A lighting module, comprising:
an optical element on a conductive connection adapter, the conductive connection adapter allowing the lighting module to be capable of connecting to a fixture;
a remote PSU; and
a remote wavelength conversion material over said optical element, wherein the module is arranged to have a substantially uniform emission pattern.

124. The lighting module of claim 123, further comprising a heat sink.

125. The lighting module of claim 123, in which the optical element is placed on a thermally conductive collar which is on the conductive connection adapter.

126. The lighting module of claim 125, further comprising a diffuser on said conductive collar and spaced apart from said optical element.

127. The lighting module of claim 123, further comprising an electronic compensation circuit integrated into the optical element.

128. The lighting module of claim 123, emitting an emission pattern that complies with the ENERGY STAR® requirements.

129. The lighting module of claim 123, emitting an emission profile equivalent to fixtures with omnidirectional ENERGY STAR® compliant lamps, when the module is placed within the fixture, such that the fixture comprises fixture level diffusion or scattering elements.

130. The lighting module of claim 124, in which a top of said heat sink does not extend beyond outer lateral edge of said optical element.

131. The lighting module of claim 123, wherein said wavelength conversion material comprises a wavelength converter carrier having a thermally conductive material.

132. The lighting module of claim 126, wherein said diffuser at least partially conceals the appearance of said wavelength conversion material when said lighting module is not operating.

133. The lighting module of claim 123, in which the optical element is non-planar.

134. The lighting module of claims 123, providing a steady state lumen output of at least 800 lumens.

135. The lighting module of claim 123, providing a steady state lumen output of 65 lumens per watt or more.

136. The lighting module of claim 123, wherein light emitted from the lighting module has an even spatial intensity uniformity in a range of viewing angles from 0 to 135° with the intensity differing ≦50% from the mean intensity within that range.

137. The lighting module of claim 136, having greater than 5% of total luminous flux in the 135 to 180° viewing angles.

138. The lighting module of claim 123, in which the PSU is physically remote from the lighting module and electrically connected through a conductor.

139. The lighting module of claim 123, in which the module is connected to a fixture and is capable of dissipating heat from said module through said conductive connection adapter to said fixture.

140. The lighting module of claim 125, in which the conductive collar comprises a reflective surface with at least 96% reflectivity.
